(19) United States
(12) Patent Application Publication
(10) Pub. No.: US 2026/0287772 A1
(43) Pub. Date: Sep. 24, 2026

(54) Methods and Systems of Target-Oriented Full-Waveform Inversion

(71) Applicant: BP Corporation North America Inc., Houston, TX (US)

(72) Inventors: Simon Luo, Houston, TX (US); Xiaolei Song, Katy, TX (US)

(73) Assignee: BP Corporation North America Inc., Houston, TX (US)

(21) Appl. No.: 19/574,176

(22) Filed: Mar. 20, 2026

Related U.S. Application Data
(60) Provisional application No. 63/775,733, filed on Mar. 21, 2025.

(51) Int. Cl. G01V 1/28; G01V 1/30; G01V 1/34

(52) U.S. Cl. CPC G01V 1/282; G01V 1/303; G01V 1/345

(57) ABSTRACT

A method includes identifying an area of interest (AOI) in a subsurface region based on a velocity model computed based on input seismic data; muting a portion of the input seismic data based on reflection energy received from an impedance boundary in the subsurface region and applying a data mask to remaining input seismic data; performing a first full-waveform inversion (FWI) to update the velocity model from a depth associated with the impedance boundary using the input seismic data after muting and applying the data mask to obtain an updated velocity model; generating a model mask for the updated velocity model based on the AOI and the impedance boundary; and performing a second FWI to update the updated velocity model using the model mask and the input seismic data after muting and applying the data mask and smoothing the gradient to enhance a seismic image at the AOI.

### CROSS-REFERENCE TO RELATED APPLICATIONS

The present application claims priority to U.S. Provisional Application No. 63/775,733 filed on Mar. 21, 2025 and entitled, “METHODS AND SYSTEMS OF TARGET-ORIENTED FULL-WAVEFORM INVERSION,” which is incorporated herein by reference in its entirety.

### BACKGROUND

Seismic surveying is a geophysical technique used to investigate the subsurface structure of the Earth by sending shock waves or vibrations into the ground and analyzing the reflected waves. Seismic waves are reflected and/or refracted when they encounter boundaries between different layers of subsurface materials, such as rock, sediment, or fluid. These layers have different densities, which cause the seismic waves to change speed and direction upon encountering the boundary. When a seismic wave propagates through the Earth and strikes a boundary between materials of different densities, a part of the seismic wave energy is transmitted into the new layer as the refracted energy and the remainder is reflected back toward the surface as the reflection energy. The reflected seismic wave energy is observed at the surface as seismic data and may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. Furthermore, the seismic data observed by the receivers may also be used to create an image or profile of the corresponding subsurface region. Interpretation of these seismic images may provide a description of composition, density, and depth of subsurface materials and aids in resource extraction, hazard assessment, and environmental impact studies of the subsurface.

### SUMMARY

In an embodiment, method comprises identifying an area of interest (AOI) in a subsurface region of Earth based on a velocity model computed based on input seismic data; muting at least a portion of the input seismic data based on reflection energy received from an impedance boundary in the subsurface region and applying a data mask to remaining input seismic data; performing a first full-waveform inversion (FWI) to update the velocity model from a depth associated with the impedance boundary using the input seismic data after muting and applying the data mask to obtain an updated velocity model; generating a model mask for the updated velocity model based on the AOI and the impedance boundary; and performing a second FWI to update the updated velocity model using the model mask and the input seismic data after muting and applying the data mask and smoothing the gradient to enhance a seismic image at the AOI. In some embodiments, before applying the data mask to the remaining input seismic data, the method further comprises selecting seismic sources based on at least one of a shape of the impedance boundary, a location of the impedance boundary, or the AOI. In some other embodiments, before selecting the seismic sources, the method further comprises obtaining the shape and the location based on the velocity model. In certain embodiments, before obtaining the shape and the location, the method further comprises performing an initial FWI to obtain the velocity model. In some embodiments, the impedance boundary comprises a top and a base, and wherein muting at least the portion of the input seismic data and applying the data mask to the remaining input seismic data comprises muting reflections that correspond to the seismic sources and that are from a starting time to an end time corresponding to the base; and adding gain to weak events corresponding to the seismic sources using an automatic gain controller (AGC), wherein the weak events comprise interactions of the seismic sources with the base and the AOI. In some embodiments, the impedance boundary comprises a top and a base, and wherein generating the model mask comprises identifying a first area encompassing the base and the AOI based on the updated velocity model; and adding a contrast to the first area to obtain the model mask. In other embodiments, the method further comprises identifying a second area that is based on the updated velocity model and that is different from the first area, wherein a first value of the first area is 1, wherein a second value of the second area is 0, and wherein a third value of a transition area that is between the first area and the second area changes gradually from 1 to 0. In an embodiment, a computing system comprises a memory configured to store instructions; and one or more processors coupled to the memory and configured to execute the instructions to cause the computing system to identify an AOI in a subsurface region of Earth based on a velocity model computed based on input seismic data; mute at least a portion of the input seismic data based on reflection energy received from an impedance boundary in the subsurface region and apply a data mask to remaining input seismic data; perform a first FWI to update the velocity model from a depth associated with the impedance boundary using the input seismic data after muting and applying the data mask to obtain an updated velocity model; generate a model mask for the updated velocity model based on the AOI and the impedance boundary; and perform a second FWI to update the updated velocity model using the model mask and the input seismic data after muting and applying the data mask and smoothing the gradient to enhance a seismic image at the AOI. In some embodiments, before applying the data mask to the remaining input seismic data, the one or more processors are further configured to execute the instructions to cause the computing system to select seismic sources based on at least one of a shape of the impedance boundary, a location of the impedance boundary, or the AOI. In some other embodiments, before selecting the seismic sources, the one or more processors are further configured to execute the instructions to cause the computing system to obtain the shape and the location based on the velocity model. In other embodiments, before obtaining the shape and the location, the one or more processors are further configured to execute the instructions to cause the computing system to perform an initial FWI to obtain the velocity model. In some embodiments, the impedance boundary comprises a top and a base, and wherein the one or more processors are further configured to execute the instructions to cause the computing system to mute reflections that correspond to the seismic sources and that are from a starting time to an end time corresponding to the base; and add gain to weak events corresponding to the seismic sources using an AGC, wherein the weak events comprise interactions of the seismic sources with the base and the AOI. In some other embodiments, the impedance boundary comprises a top and a base, and wherein the one or more processors are further configured to execute the instructions to cause the computing system to identify a first area encompassing the base and the AOI based on the updated velocity model; and add a contrast to the first area to obtain the model mask. In certain embodiments, the one or more processors are further configured to execute the instructions to cause the computing system to identify a second area that is based on the updated velocity model and that is different from the first area, wherein a first value of the first area is 1, wherein a second value of the second area is 0, and wherein a third value of a transition area that is between the first area and the second area changes gradually from 1 to 0. In an embodiment, a computer program product comprising computer-executable instructions that are stored on a non-transitory computer-readable medium and that, when executed by one or more processors, cause a computing system to identify an AOI in a subsurface region of Earth based on a velocity model computed based on input seismic data; mute at least a portion of the input seismic data based on reflection energy received from an impedance boundary in the subsurface region and apply a data mask to remaining input seismic data; perform a first FWI to update the velocity model from a depth associated with the impedance boundary using the input seismic data after muting and applying the data mask to obtain an updated velocity model; generate a model mask for the updated velocity model based on the AOI and the impedance boundary; and perform a second FWI to update the updated velocity model using the model mask and the input seismic data after muting and applying the data mask and smoothing the gradient to enhance a seismic image at the AOI. In some embodiments, before applying the data mask to the remaining input seismic data, the computer-executable instructions, when executed by the one or more processors, further cause the computing system to select seismic sources based on at least one of a shape of the impedance boundary, a location of the impedance boundary, or the AOI. In some other embodiments, before selecting the seismic sources, the computer-executable instructions, when executed by the one or more processors, further cause the computing system to perform an initial FWI to obtain the velocity model; and obtain the shape and the location based on the velocity model. In other embodiments, the impedance boundary comprises a top and a base, and wherein the computer-executable instructions, when executed by the one or more processors, further cause the computing system to mute reflections that correspond to the seismic sources and that are from a starting time to an end time corresponding to the base; and add gain to weak events corresponding to the seismic sources using an AGC, wherein the weak events comprise interactions of the seismic sources with the base and the AOI. In some other embodiments, the impedance boundary comprises a top and a base, and wherein the computer-executable instructions, when executed by the one or more processors, further cause the computing system to identify a first area encompassing the base and the AOI based on the updated velocity model; and add a contrast to the first area to obtain the model mask. In certain embodiments, the computer-executable instructions, when executed by the one or more processors, further cause the computing system to identify a second area that is based on the updated velocity model and that is different from the first area, wherein a first value of the first area is 1, wherein a second value of the second area is 0, and wherein a third value of a transition area that is between the first area and the second area changes gradually from 1 to 0.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system according to various embodiments disclosed herein;

FIG. 2 is a schematic diagram of an embodiment of a system for performing a marine seismic survey according to various embodiments disclosed herein;

FIG. 3 is a schematic diagram of an embodiment of a system for performing a land-based seismic survey according to various embodiments disclosed herein;

FIG. 4 is a block diagram of an embodiment of a computing system that may perform operations described herein based on data acquired via the marine survey system of FIG. 2 and/or the land survey systems of FIG. 3 according to various embodiments described herein;

FIG. 5 depicts a velocity model of a subsurface region according to various embodiments described herein;

FIG. 6 depicts an AOI of the subsurface region according to various embodiments described herein;

FIG. 7A depicts a reflection seismic section of a single seismic shot (source) corresponding to the area of interest according to various embodiments described herein;

FIG. 7B depicts another reflection seismic section of the single seismic shot (source) corresponding to the area of interest according to various embodiments described herein;

FIG. 7C depicts a data mask corresponding to the area of interest according to various embodiments described herein;

FIG. 8 depicts an updated velocity model of the subsurface region according to various embodiments described herein;

FIG. 9 depicts a model mask corresponding to the AOI according to various embodiments described herein;

FIG. 10 is a flowchart of an embodiment of a method of target-oriented FWI according to various embodiments described herein; and

FIG. 11 depicts a velocity model of the subsurface region after applying the data mask and the model mask and performing the FWI according to various embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to...” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

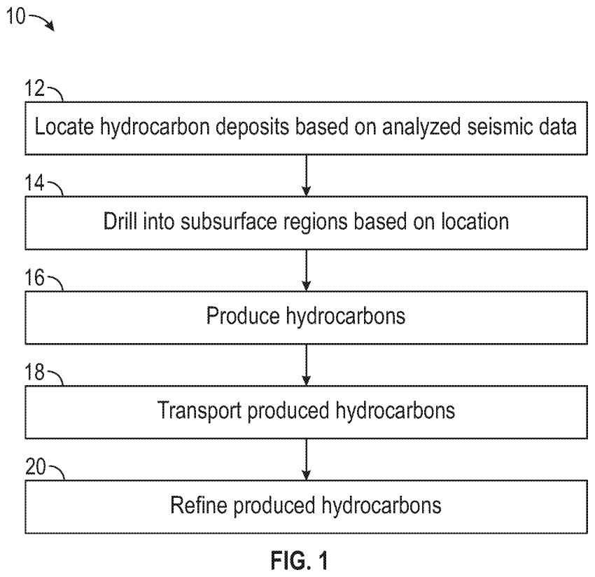

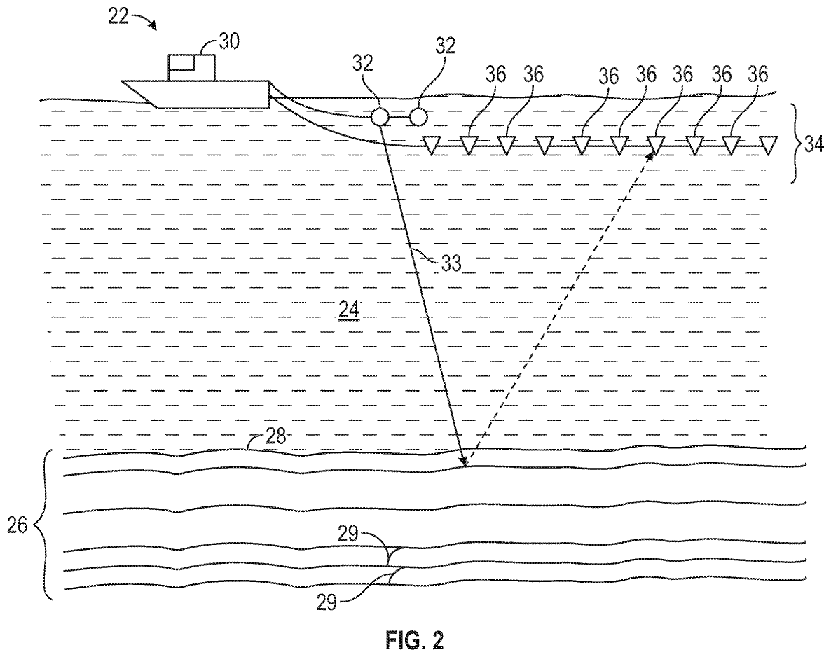

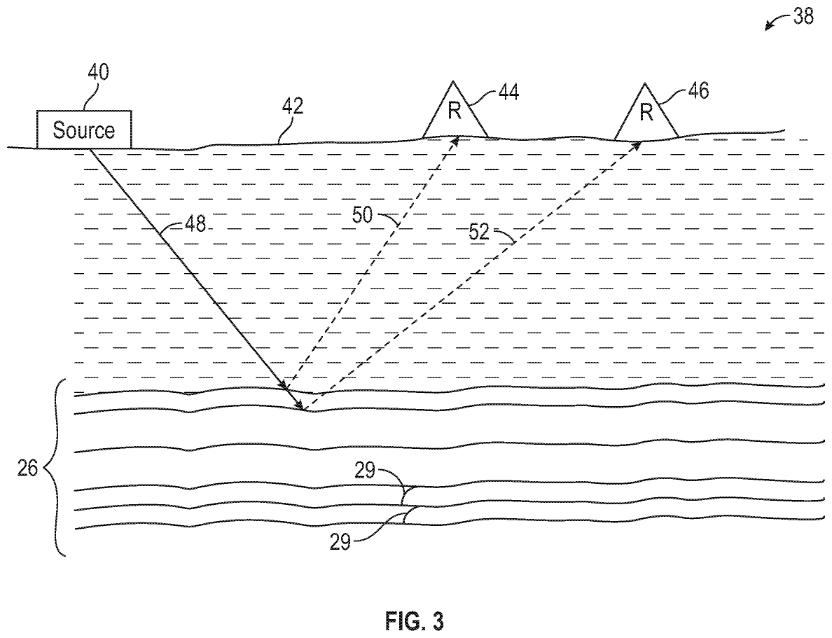

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth, in particular receivers in the water column or on the sea floor (e.g. “ocean-bottom nodes”, “ocean-bottom cables”, or “distributed acoustic sensing” fiber-optic cables). The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being interacted with various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator, dynamite, thumper, etc.) may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of, or otherwise interact with, the geological formations (e.g., subsurface reflectors 29) and then be acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may interact with one or more different geological formations and then be received by one or more receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

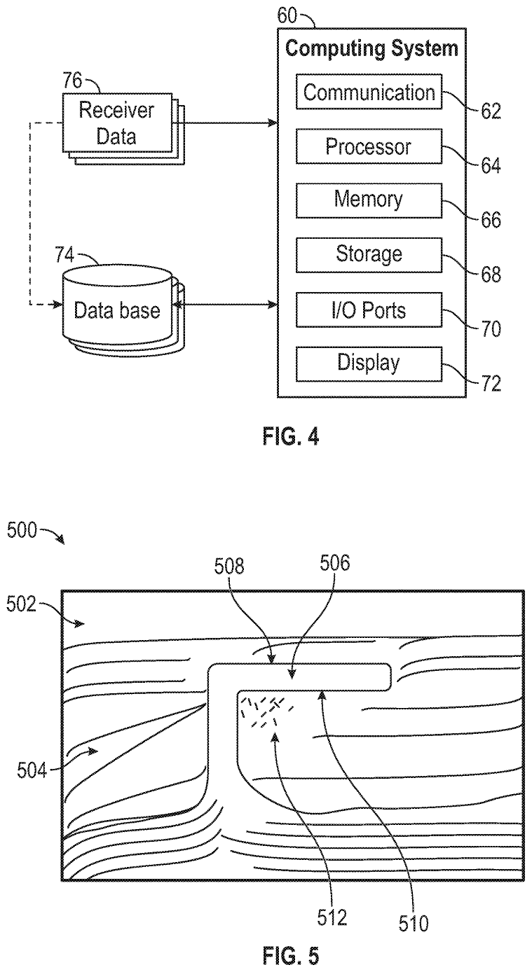

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location, and the properties of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the I/O ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. The processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, I/O modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location, and the properties of hydrocarbon deposits within the subsurface region 26, predictions of seismic properties associated with one or more wells in the subsurface region 26, and the like. The display 72 may be any suitable type of display, such as a liquid-crystal display (LCD), plasma display, or an organic light-emitting diode (LED) (or OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional (2D) representation or a three-dimensional (3D) representation of the subsurface region 26 based on the seismic data received via the receivers mentioned above. Additionally, seismic data associated with multiple source/receiver combinations may be combined to create a near continuous profile of the subsurface region 26 that can extend for some distance. In a 2D seismic survey, the receiver locations may be placed along a single line, whereas in a 3D survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26.

In addition, a four-dimensional (4D) (or time-lapse) seismic survey may include seismic data acquired during a 3D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys probe features in the subsurface regions of the Earth using vibrational waves in order to collect information regarding the subsurface regions. The information collected from the reflected, refracted, converted, etc., seismic waves may be used to create subsurface models that include velocity models and seismic images, which may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

Seismic imaging usually includes a two-step process. First, a velocity model of the subsurface region is estimated. Then, seismic traces obtained from a seismic survey are combined with the estimated velocity model to generate an image of the subsurface structure using migration or imaging algorithms. As used herein, “migration” refers to a seismic data processing technique which shifts or relocates seismic reflections captured in the observed seismic data to or at least towards their true physical positions in the subsurface region to create an image. As used herein, “observed seismic data” refers to data that is captured by one or more seismic receivers as seismic signals reflected by the subsurface region and which are originally generated by one or more corresponding sources. In some applications, an iterative data-fitting process such as an acoustic, elastic, or multi-parameter FWI process may be applied to observed seismic data (e.g., seismic data collected using a seismic survey system such as survey systems 22 and 38) to form a velocity model therefrom. In some applications, instead of using an imaging algorithm, an image of the subsurface structures may be created directly from the velocity model (i.e. FWI-derived reflectivity (FDR)).

The FWI process is an advanced geophysical technique used to image subsurface structures, providing high-resolution models of the Earth's interior. Furthermore, seismic inversion methods, such as acoustic FWI may focused on estimating parameters like compressional (P) wave velocity and elastic FWI incorporates both compressional (P) and shear(S) waves in the modelling and inversion process. Elastic FWI uses a more accurate representation of the governing physics and hence, the elastic FWI approach enhances the resolution and accuracy of subsurface models, especially in complex geological settings where wave mode conversions perform a significant role.

The FWI process is an optimization-based seismic imaging technique that attempts to iteratively minimize the difference (or misfit, residue) between observed seismic data and modeled seismic data generated from a subsurface model (e.g., FWI objective function). Unlike methods that use simplified seismic arrivals or travel times (e.g., travel-time inversion), FWI uses the full range of seismic waveforms. This results in more detailed and accurate model of the subsurface.

Further, an elastic FWI process is different from acoustic FWI methods that only use P-waves for modeling seismic data. While the acoustic FWI process is sufficient for environments where shear waves do not significantly affect wave propagation (e.g., simple marine environments), elastic FWI may be used in land-based and geologically complex areas (e.g. complex marine settings such as sub-salt or sub-basalt) where both P-waves and S-waves may be important for accurate imaging and understanding of subsurface properties.

The FWI process begins with data acquisition, where seismic data is collected using arrays of receivers such as receivers 36, 44, and 46 in FIGS. 2 and 3. This data includes P-waves and/or a mix of P-waves and S-waves. Next, an initial subsurface model is created, based on prior geological knowledge or simplified inversion techniques. Using this initial model, modeled seismic data is generated through forward modeling, which solves the equations of motion for elastic wave propagation.

The difference between the observed/recorded seismic data and modeled seismic data is then calculated using a misfit function such as the least squares norm, which measures how well the modeled seismic data matches the recorded seismic data. The goal is to iteratively refine the subsurface model by minimizing this misfit through optimization algorithms, for example, using gradient-based methods. The model parameters, including P-wave and S-wave velocities and/or density, may be adjusted at each step to reduce the misfit between recoded seismic data and the modeled seismic data. The above process is repeated iteratively until the misfit reaches an acceptable level (e.g., a threshold level), resulting in a final subsurface model that provides high-resolution estimates of the geological parameters. These parameters may include P-wave and S-wave velocities, density, and other relevant elastic parameters, all of which may contribute to a detailed image of the subsurface that is crucial for geological interpretation and exploration.

The FWI process is computationally intensive, especially for large-scale, production-level seismic datasets. Herein, “production-level seismic datasets” refer to large, high-volume collections of seismic data acquired during extensive surveys, and may be used for practical applications such as geophysical exploration, oil and gas reservoir analysis, or subsurface investigations. These datasets may be characterized based on size, often consisting of tens of millions of seismic traces collected over vast areas, and use significant computational resources to process. In the context of FWI, production-level datasets may be used for generating detailed subsurface models, and FWI algorithms are tasked with optimizing the subsurface model in such a way that the overall misfit (often measured using L2 or L1 norms) between the observed seismic data and modeled seismic data is minimized for the entire dataset simultaneously.

However, in some cases, it may be advantageous to look into a specific region of the subsurface model rather than the entire volume. For instance, a geophysical study may focus on a particular feature such as a sediment-salt interface, which may be of critical interest due to geological importance or potential impact on hydrocarbon reservoirs. In these situations, the standard FWI process may be sub-optimal. For instance, the standard FWI process may be used to minimize the difference between the observed and modeled data everywhere in the model simultaneously. Therefore, the AOI comprises only a small part of the overall minimization goal and hence it may only be updated by a small amount with each iteration, or may not be usefully updated at all.

The challenge with the FWI approach is that the FWI approach may seek a global solution for the entire model and may not provide a way to focus the inversion efforts on the desired specific areas of interest. In other words, FWI may treat all parts of the model equally, even though in practice, some areas, such as the sediment-salt interface or impedance contrasts in different areas, are of greater interest to the user but the FWI approach may struggle to provide a high-resolution image due to poor wave propagation.

The present disclosure solves the aforementioned technical problem by providing a target-oriented FWI method to focus the inversion efforts on an AOI within the subsurface model such that the resolution of the AOI can be improved.

Referring now to FIG. 5, shown is a velocity model 500 of a subsurface region. In FIG. 5, an area 502 represents the water, an area 504 represents a sedimentary area, and an area 506 represents a high velocity area. Further, as shown in FIG. 5, the high velocity area 506 includes a top 508 and a base 510. Herein, the top 508 is a high-impedance boundary, such as a sediment-salt interface and the base 510 is another high-impedance boundary, such as a sediment-salt interface. In many geological settings, such as in offshore basins or areas with ancient evaporite deposits, salt deposits may be found beneath layers of sediment. The sediment-salt interface marks the transition from the porous and less dense sediment area 504 to the highly impermeable and ductile salt area 506. This sediment-salt interface is significant in terms of hydrocarbon traps as salt acts as an impermeable seal, trapping hydrocarbons in the overlying sedimentary area 504. In an embodiment, the velocity model 500 of the subsurface region further includes an area of interest (AOI) 512 at least partially covered or enclosed by the salt area 506, and therefore, the AOI 512 may be a possible trapped hydrocarbon location of the sediment area 504.

As shown in FIG. 5, the velocity model 500 used for forward modeling in seismic imaging represents the initial estimation of the subsurface seismic velocity structure. Herein, the forward modeling may represent the process of simulating seismic wave propagation, based on a predefined subsurface model and including reflections, refractions, and scattering, through the earth. The result of the forward modeling may provide modeled seismic data. The velocity model 500 is an input of the forward modeling process. The velocity model 500 provides a first approximation of the seismic velocities (such as P-wave and/or S-wave velocities) at various depths and locations within the subsurface.

The velocity values at different depths may be selected based on prior geological knowledge or initial estimates from well logs, regional surveys, rough geological assumptions, or a prior acoustic FWI process to obtain a kinematically accurate velocity model. The velocity model 500 may ideally capture the general structure of the subsurface, including major areas like sediments, rock formations, faults, or other significant geological features.

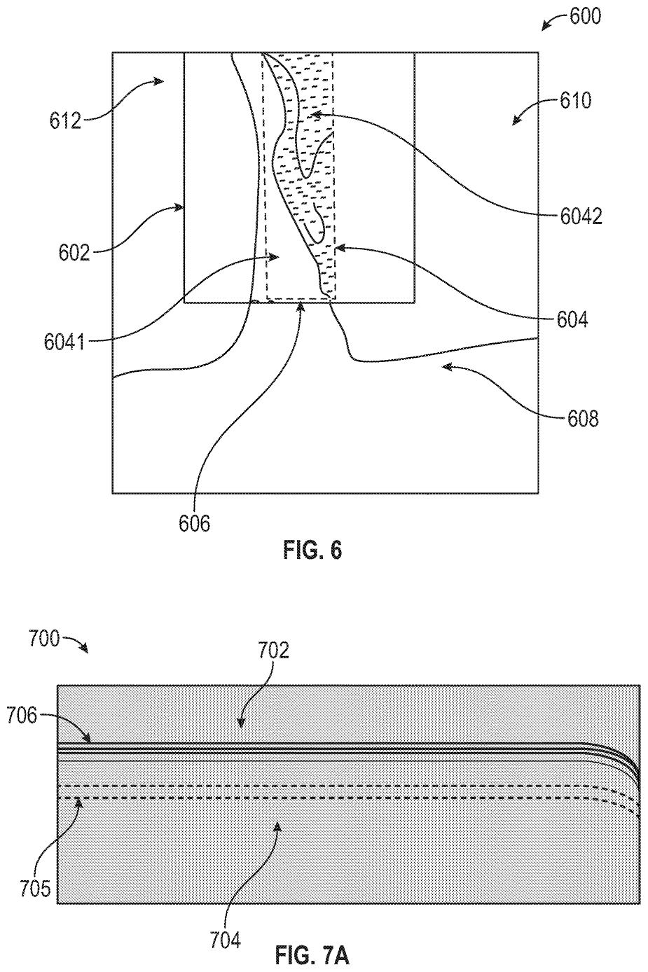

Referring to FIG. 6, an AOI within a subsurface region 600 is illustrated. In FIG. 6, the subsurface region 600 is shown in the X-Y plane, with the AOI delineated by box 604 and the seismic sources (shots) selected based on a high impedance area (e.g., salt area) shape, location, seismic survey geometry, and the AOI are outlined by box 604. The AOI, enclosed by box 604, is situated inside the broader of the seismic sources (shots) selected, enclosed by box 602. The sizes and shapes of these boxes 602 and 604 are arbitrary and may be influenced by the shape, geometry, and location of the high impedance area (e.g., salt area) as well as the geometry of the AOI. For example, as shown in FIG. 6, the subsurface region 600 contains a salt area 608 that spans from the bottom to the top of the subsurface region, with an arbitrary shape. Furthermore, at the top of the subsurface region 600, the salt area 608 becomes narrower and interweaved between two sediment areas 610 and 612 of the subsurface region 600. Consequently, the AOI within the box 604 encompasses both a salt portion 6041 of the salt area 608 and a sediment portion 6042 of the sediment area 610 when defining the AOI for further analysis.

A high impedance area like the salt area 608 in the subsurface region 600 creates challenges in seismic imaging due to significantly different velocity values compared to surrounding sediment areas 610 and 612. Seismic waves may propagate around the salt rather than through it, or the seismic waves may be refracted and attenuated by the salt area 608 itself. This results in an inability to obtain clear and accurate data about the underlying AOI, which complicates velocity updates in regions impacted by the salt area 608. The presence of the salt area 608 may obscure some of the seismic reflections, making it difficult to accurately image subsurface features beneath or adjacent to the salt area.

The subsurface area enclosed by the box 602 is the specific region that influences the AOI and may benefit from an improved resolution due to the presence of a high impedance area (e.g., the salt area). The AOI may be located beneath or next to the salt area and the seismic imaging methods may struggle to clearly capture the subsurface characteristics due to the interference caused by the high impedance area. Understanding the shape and geometry of the high impedance area is essential, as it may determine the extent to which the salt area influences seismic wave propagation. The high impedance area's geometry, whether a complex structure or a more regular form, is considered when selecting seismic shots (or sources) and determining the most effective strategy for imaging the AOI.

In target-oriented FWI, the first step may include selecting seismic shots (or sources) based on a high impedance area (e.g., salt area) shape, location, geometry, and the AOI, and may further focus on the shots that will provide the most relevant data for the AOI, while avoiding unnecessary interference from the high impedance area. The selection process emphasizes shots located within the AOI to ensure that the selected shots may provide useful information about the subsurface in the AOI. Furthermore, the selection process may include avoiding the selection of seismic shots (sources) that may be influenced by the high impedance area as the seismic waves that pass through or are refracted by the high impedance area are less likely to reach the AOI. The selected shots may have pathways that pass through or near the AOI, optimizing wavefield coverage and helping to improve resolution in the AOI. Strategic shot placement or selection may be important as a well-distributed set of sources provides varied travel paths that enhance the accuracy of the inversion process and help to mitigate noise from the high impedance layer.

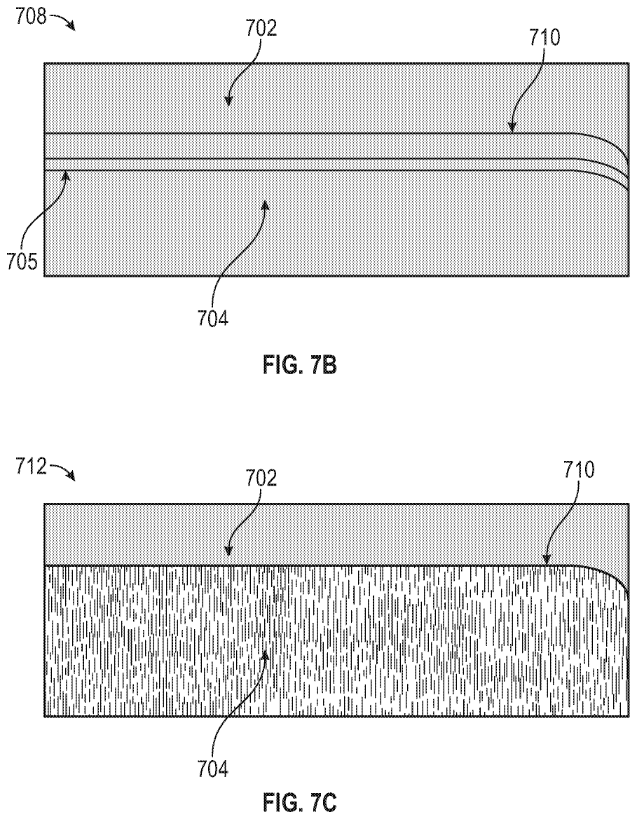

Referring now to FIGS. 7A and 7B, shown are reflection seismic sections of a single seismic shot (source) corresponding to the area of interest. Specifically, FIG. 7A shows a reflection seismic section of a single seismic shot (source) corresponding to the area of interest. The FIG. 7B depicts another reflection seismic section of the single seismic shot (source) corresponding to the area of interest.

Turning first to FIG. 7A, a reflection seismic section 700 is shown for a single seismic shot (source) corresponding to the area of interest. In this seismic section 700, the X-axis represents the horizontal distance between the source and the receiver, while the Y-axis denotes the two-way travel time of the seismic waves. The two-way travel time refers to the total duration it takes for a seismic wave to propagate from the seismic source, reflect off (or refract or transmit through) a subsurface layer (such as the salt area 506 shown in FIG. 5 or a salt area 608 shown in FIG. 6), and return to the receiver. This time represents the round-trip journey of the seismic wave through the subsurface and is measured in milliseconds (ms) or seconds(s). The two-way travel time is used to calculate the depth of subsurface layers, using the seismic wave velocity, and may be useful for interpreting seismic data.

As illustrated in FIG. 7A, following a single seismic shot, the generated seismic waves may reflect from impedance boundary, such as the salt area 506 shown in FIG. 5. If the salt area is thick, multiple reflected signals, such as those shown in signals 706, may occur and propagate through area 702 to the receivers. The strong reflected signals 706 may be generated from the upper layers of the impedance boundary, while weaker reflected signals 705 may originate from the deeper layers of the underlying AOI and/or the base of the impedance boundary.

Moreover, if the impedance boundary is particularly thick, the seismic waves may not reach or may only partially reach the AOI. This is due to the thick impedance boundary either obstructing or attenuating the seismic energy before it can interact with deeper structures surrounded or covered by the impedance boundary. As a result, the energy of the incident seismic waves may not sufficiently reach the AOI, leading to low-resolution seismic images. This effect can occur with any FWI processes and limits the resolution of subsurface imaging.

A proposed method to overcome the aforementioned technical problems that result when a high impedance area obstructs the AOI may involve removing strong reflections by muting signals from time t=0 to a bottom of the impedance boundary, and enhancing the amplitudes of weaker signals or events by applying a data mask.

Now referring to FIG. 7B, a reflection seismic section 708 of the single seismic shot (source) corresponding to the area of interest is shown. The reflection seismic section 708 shown in FIG. 7B includes events below the top of the impedance boundary 710. The main difference between FIG. 7A and FIG. 7B is that in FIG. 7B, a data mask has been applied, and the reflected seismic signals 706 shown in FIG. 7A are muted. Specifically, compared to FIG. 7A, FIG. 7B does not show the reflected seismic waves 706 in area 702, which is the direct result of muting. Additionally, the weak signals or events 705 generated by the interaction of incident seismic waves with the underlying AOI and/or the base of the impedance boundary, are enhanced by the application of the data mask.

Herein, the term muting refers to a seismic data processing technique used to eliminate unwanted portions of data that is caused by strong reflections or noisy events that may interfere with the inversion process. In this context, muting may be applied in two manners. First, a time mute may be applied from t=0 (the start time) to a time when the incident seismic wave signal is at just below the top of the impedance boundary (e.g., the top 508 as shown in FIG. 5), effectively removing reflections from shallow structures and/or surface layers that could distort the inversion process for the AOI beneath the impedance boundary. The reflections from shallow structures and/or the surface layers may represent the boundary where seismic waves are initially reflected or refracted by the impedance boundary. By muting these reflections, which may otherwise dominate the seismic signal, surface-level information that could obscure subsurface features may be excluded. Second, another time mute may be applied from a time when the incident seismic wave signal is at just below the top of the impedance boundary (e.g., the top 508 as shown in FIG. 5) to a time when the incident seismic wave signal is at just above the base of the impedance boundary (e.g., the base 510 as shown in FIG. 5). This may allow the inversion to focus solely on signals originating from the just above the base of the impedance boundary and signals from the underlying AOI beneath the impedance boundary, which may lead to improved resolution of the AOI. This creates a time window in which the relevant data from just above the base of the impedance boundary and below the impedance boundary including data from the underlying AOI are used, ensuring that the data most relevant to the AOI contribute to the inversion, thereby enhancing the quality and accuracy of subsurface imaging.

Now referring to FIG. 7C, a data mask 712 corresponding to the AOI is shown. Specifically, the data mask 712 shown in FIG. 7C is developed using AGC such that the area 704 is enhanced to balance out amplitude differences in the reflected seismic signals.

In an embodiment, enhancing the amplitudes of weaker signals or events by applying the data mask such as the data mask 712 includes use of AGC. The AGC is a technique employed to adjust the amplitude of seismic signals in order to enhance the visibility of weaker signals or events generated from deeper regions or areas affected by attenuation, while reducing the strength of stronger signals, often originating from near-surface or shallow events. This adjustment improves the overall signal-to-noise ratio, particularly in datasets where the amplitude varies significantly across time or space. The gain function calculated by AGC balances the energy levels within the seismic data, reducing the influence of high-amplitude signals that may dominate the dataset. As a result, AGC allows for improved visibility and interpretation of weaker, deeper signals, thereby enhancing the quality of seismic data and enabling more accurate analysis of subsurface features.

After applying the AGC, a data mask is generated to selectively focus on the relevant parts of the seismic data for inversion, while the regions that are less significant, such as overly strong or noisy reflections, are muted (as described above). In an embodiment, amplitudes of the weaker reflected signals 705 shown in FIG. 7A may be adjusted, using the data mask 712 as shown in FIG. 7C, to obtain enhanced reflected signals 705 such as shown in FIG. 7B.

Data masking may include setting a threshold based on the calculated gain to emphasize signals from the AOI, which may be weak due to factors like salt attenuation and/or the presence of high impedance boundaries/layers, while disregarding stronger signals that may not contribute effectively to improving the velocity model for the AOI. The data mask may be created by defining an acceptable gain threshold and may retain areas where the gain exceeds this threshold for the inversion process, whereas regions with gain values below the threshold may be either discarded or down-weighted. This approach may filter out high-amplitude reflections, which could otherwise interfere with the inversion or lead to an overemphasis on non-target areas, such as reflections from shallow layers or those above the salt/high impedance layer. By doing so, data masking enhances the accuracy and focus of the seismic inversion.

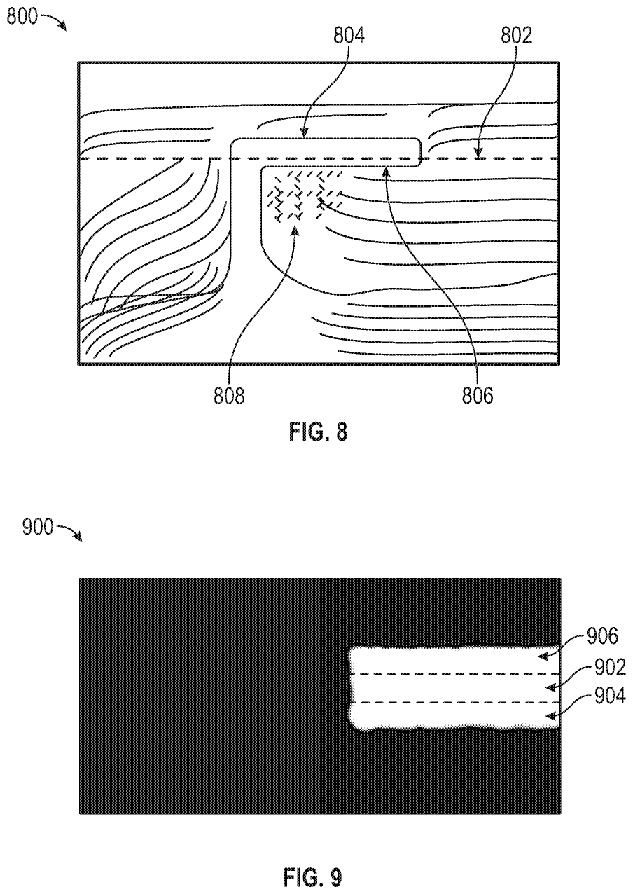

Referring to FIG. 8, an updated velocity model 800 is shown, which may be obtained after performing the FWI process on the velocity model 500 from FIG. 5 based on the data mask applied to the seismic data as discussed in FIGS. 7A-B. In an embodiment, the FWI process may be applied starting from the depth corresponding to line 802 and extending to the bottom of the subsurface region. Line 802 is located between a top 804 of the impedance boundary and a base 806 of the impedance boundary, and closer to the base 806. Additionally, the data mask, which focuses on the AOI, may be applied to the data, and the reflected seismic waves from the time range between t=0 and time when the incident seismic signal is at just above the base 806 may be muted during the FWI process. As shown in the updated velocity model 800, the AOI 808 exhibits a higher resolution compared to the AOI 512 in the velocity model 500 from FIG. 5.

The process of updating the velocity model for FWI may be focused on the region between just above the base (e.g., sediment-salt interface) of the impedance boundary and the bottom of the subsurface. This depth range may be selected to exclude the top (e.g., sediment-salt interface) of the impedance boundary and the shallow regions above the top of the impedance boundary, where reflections may be dominated by strong near-surface structures. Although the impedance boundary introduces significant velocity contrasts, the base of the impedance boundary and the high-impedance flanks adjacent to the AOI may influence seismic wave propagation. Therefore, these areas may have to be considered for modeling the interactions between seismic waves and the impedance boundary, as they may distort the waves passing through or around the impedance boundary.

As described above, seismic waves interacting with the impedance boundaries (e.g., salt layers) may create complex reflections that distort the seismic data. The high impedance may obscure information about deeper layers such that avoiding high impedance and concentrating on the AOI beneath the high impedance may allow for a more accurate representation of the subsurface. This may be the case when other inversions failed to resolve the deeper layers due to the interference caused by the high impedance layers.

Furthermore, performing the FWI process may begin using an initial velocity model that is obtained from a previous FWI process, which may have been improved above the salt/high impedance layer, but may use further improvement below the salt/high impedance layer. The FWI process in the AOI may focus on improving the velocity model to better match the observed seismic data. This iterative process may adjust the velocity model by comparing synthetic data with real seismic data, using waveform matching to minimize the misfit. Gradients of the misfit function may be calculated to iteratively update the velocity model, improving the resolution and accuracy of the subsalt region. Throughout the iterations, the model converges towards a more accurate representation, particularly in areas with good data coverage or high sensitivity to velocity changes. The velocity model update may extend to the bottom of the subsurface to maintain consistency across the entire geological section.

FIG. 9 shows a model mask 900 generated based on the updated velocity model 800 from FIG. 8. Furthermore, the model mask 900 may be generated by a user based on the location of the AOI. The model mask 900 consists of three distinct areas: a first area 902, a second area 904, and a third area 906. In the model mask 900, regions outside of these areas are assigned a value of 0, represented by black color. The first area 902 is assigned a value of 1, corresponding to white color, while the second area 904 and the third area 906 have values ranging between values 0 and 1. The edges of the second area 904 and the third area 906 that are closer to the first area 902 have values closer to 1, while the edges of the second area 904 and the third area 906 near regions outside the first area 902, the second area 904, and the third area 904 have values closer to 0. Therefore, the boundaries coupling the white and black regions have gradual taper shading from white to black in the second area 904 and the third area 906. These gradual transition regions may avoid introducing abrupt discontinuities in the velocity model. The widths of these transition regions may be selected by the user based on the shape of the AOI. In the model mask 900, the first area 902 corresponds to the AOI at a defined depth, the second area 904 corresponds to the deeper layers below the AOI, and the third area 906 corresponds to the base 806 shown in FIG. 8.

A model mask may be a computational region or a mathematical region that may define parts of the velocity model that may be updated during the FWI process and which areas may remain fixed or excluded. For example, in the model mask 900 shown in FIG. 9, the regions that have the value 0 may not update, while all the other areas in the model mask may be updated and have updated velocity values corresponding to the values. Furthermore, during this step, the current velocity model, which has already undergone some updates in previous stages, may create a mask that focuses on refining the model around the AOI. This may allow the inversion effort to be concentrated where it is most needed, improving the efficiency of the FWI process.

As discussed in FIGS. 5 and 6, the AOI corresponds to the subsurface region that may use improved resolution, such as a subsurface reservoir, fault zone, or other geologically significant feature, often located below the high impedance layers. The model mask may ensure that the FWI process focuses on enhancing the velocity model around this region, prioritizing areas that may directly benefit from inversion. In the example described herein, the model mask may be useful during the process of updating the subsalt region and parts of the sediments surrounding the subsalt region, where the target geological features are located.

Regions above the base of the impedance boundary, including the top of the impedance boundary and shallow sediment layers, often exhibit strong contrasts that can distort the velocity structure. These areas are generally well updated in earlier stages of the inversion process and do not require further refinement at this stage. The model mask may exclude these regions to avoid unnecessary computational effort on areas where the velocity model may converge or where additional updates would not significantly improve the resolution of the AOI. Furthermore, the embodiments disclosed herein leverage a data mask and a model mask, which may work in tandem to significantly enhance computational efficiency. This combination may allow for the modeling of subsurface regions with high impedance areas, enabling the generation of high-resolution images of the subsurface at a fraction of the computational cost compared to prior methods.

Therefore, the model mask may ensure that the FWI process is concentrated on the AOI that may improve the resolution of the target subsurface area, while avoiding unnecessary updates to already well-modeled regions. This leads to a more efficient inversion process and results in a higher-resolution velocity model for the subsalt region, where the most relevant geological information is located.

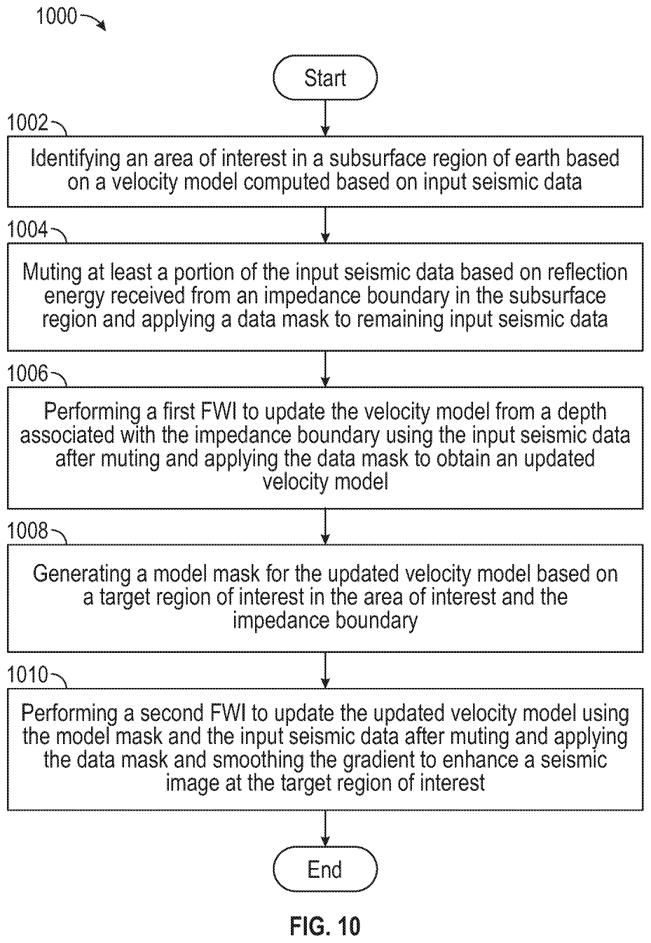

Referring now to FIG. 10, shown is a flowchart of an embodiment of a method 1000 of target-oriented FWI according to various embodiments described herein. At least some, if not all, of the steps of method 1000 shown in FIG. 10 may be executed by the computing system 60 shown in FIG. 4, although it may be understood that at least some of the steps of method 1000 may be executed by systems other than computing system 60. Additionally, it may be understood that the migration of seismic data described by method 1000 may be used for a variety of purposes, including volumetric analysis and in the planning hydrocarbon exploration, which would extend through the subsurface region. Thus, method 1000 may be used in the process of generating final seismic data including final migrated seismic data, which may include, for example, final migrated seismic gathers and/or one or more final stacked seismic images of the subsurface region. The final seismic data/models generated by method 1000 may be used to identify subterranean features of interest such as, for example, hydrocarbon deposits. The subsurface models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

Beginning at step 1002, method 1000 comprises identifying, by the computing system 60 based on the seismic data, an AOI in a subsurface region of earth based on a velocity model computed based on input seismic data. The AOI in a subsurface region of the Earth is a specific zone that may be targeted for detailed analysis and modeling because the AOI contains geological features of importance, such as oil reservoirs, gas deposits, fault zones, or other significant subsurface structures. The AOI may be identified based on a velocity model, which is a computational representation of the subsurface seismic properties, primarily focused on how seismic waves travel through different layers of the Earth.

In an embodiment, the velocity model may be derived from seismic data collected during seismic surveys. This data consists of seismic waves that are generated by seismic sources and recorded by geophones or hydrophones placed at various points on the Earth's surface or subsurface. The recorded seismic waves may interact with various subsurface layers and structures, reflecting, refracting, or being absorbed depending on the materials they encounter.

The velocity model may be then created using FWI or other inversion techniques, where the recorded seismic data is compared to synthetic data generated by an initial subsurface model. The initial subsurface model is iteratively refined until the synthetic data closely matches the observed seismic data. This process helps to estimate the velocity of seismic waves at different depths in the subsurface, which in turn reveals information about the type and distribution of materials (such as rock, water, oil, etc.) present.

The AOI may be defined within this velocity model as the region that may benefit from a higher resolution or more accurate data. For example, if the AOI is an oil reservoir or a fault zone, the AOI is typically the region beneath surface layers such as salt formations, where the velocity model used needs to be particularly refined to accurately predict the properties of the subsurface. The velocity model helps guide which areas to focus on during the inversion process, ensuring that resources may be concentrated on areas that may improve the accuracy of the model and provide better insight into the subsurface features of the AOI.

At step 1004, method 1000 comprises muting, by the computing system 60 based on the seismic data, at least a portion of the input seismic data based on reflection energy received from an impedance boundary in the subsurface region and applying a data mask to the remaining input seismic data.

In an embodiment, muting, in the context of seismic data processing, may refer to selectively removing or suppressing certain parts of the seismic data that may be considered unwanted or irrelevant for further analysis. In an embodiment, muting may be applied to the input seismic data based on the reflection energy that is received from an impedance boundary in the subsurface region.

Furthermore, the impedance boundary (sometimes referred to herein as an “impedance layer”) is a subsurface layer where there is a significant contrast in the acoustic impedance, which is the product of a material's density and its seismic velocity. When seismic waves encounter such an impedance boundary, the seismic waves are partially reflected back toward the surface. These reflections often carry strong energy that may obscure or interfere with the data from deeper layers or the AOI.

The computing system 60 may process the seismic data to identify these reflections from the impedance boundary. Once detected, the system mutes, or removes, at least a portion of the seismic data corresponding to these strong reflections. This may involve eliminating the data from time periods that correspond to the direct reflection energy from the impedance boundary, allowing the focus to shift toward the more relevant seismic signals from deeper regions or the AOI beneath the impedance boundary.

After muting the unwanted reflection energy, the computing system may apply a data mask to the remaining seismic data. The data mask adjusts the amplitudes of the signals that are still present, balancing them to ensure that weak signals or events, which may have been attenuated or otherwise distorted, are amplified, while stronger signals are reduced to maintain clarity and improve the overall signal-to-noise ratio. The purpose of this step is to enhance the seismic data from the region of interest, which helps improve the accuracy of subsequent inversion processes or analysis that depend on the data's resolution and quality.

At step 1006, method 1000 comprises performing, by the computing system 60 based on the seismic data, a first FWI to update the velocity model from a depth associated with the impedance boundary using the input seismic data after muting and applying the data mask to obtain an updated velocity model.

In an embodiment, performing a first FWI to update the velocity model from a depth associated with the impedance boundary involves using the input seismic data that has been processed through muting and data masking. The process may begin with a seismic dataset that has undergone preprocessing steps, such as removing unwanted reflections (via muting) from the impedance boundary and applying a data mask to adjust the amplitudes of the remaining seismic signals. This may ensure that the seismic data used for inversion is cleaner and more focused on the target subsurface region of interest.

The impedance boundary may refer to a subsurface layer where there is a significant contrast in acoustic impedance, which affects the reflection and refraction of seismic waves. When seismic waves interact with such boundaries, strong reflections can occur, often dominating the seismic data. The goal of the muting process is to remove these strong reflections, typically from shallow layers like the impedance boundary, so that the inversion can focus on deeper, more relevant regions, such as the area of interest below the boundary.

The first FWI is a computational technique used to iteratively update the velocity model of the subsurface. The FWI compares the observed seismic data (after muting and applying the data mask) with synthetic seismic data generated from an initial velocity model. The inversion process adjusts the velocity model iteratively, refining it to minimize the difference (misfit) between the observed and synthetic seismic waveforms. The updated velocity model will include more accurate information about the subsurface velocity structure, which is very important for accurately mapping the target area, such as an oil reservoir or fault zone, that lies beneath the impedance boundary.

By using the input seismic data that has been cleaned up (muted and masked), the first FWI focuses on updating the velocity model starting from the depth associated with the impedance boundary and extending into the deeper regions of the subsurface. This helps refine the velocity model specifically in the AOI, improving its resolution and accuracy for subsequent analysis and interpretation of the AOI. The result is an updated velocity model that better represents the subsurface characteristics below the impedance boundary.

At step 1008, method 1000 comprises generating, by the computing system 60, a model mask for the updated velocity model based on the area of interest and the impedance boundary.

In an embodiment, generating a model mask for the updated velocity model involves creating a computational mask that defines which regions of the subsurface may be updated during further seismic data processing. The primary goal may be to focus the inversion efforts on the AOI beneath the impedance boundary, where key geological features such as oil reservoirs or fault zones are located. The impedance boundary, where seismic waves experience strong reflections due to contrasts in acoustic impedance, may be excluded from intensive updates, as the reflections from these regions often dominate and interfere with the data from deeper layers.

The model mask may assign different values to the velocity model based on the location of the impedance boundary and the AOI. The target area, which lies beneath the impedance boundary, may be given a high value in the mask (e.g., 1), indicating that it should be prioritized for refinement. Regions near the impedance boundary, such as the salt body or other complex structures, may be assigned intermediate values (e.g., between 0 and 1), reflecting their influence on the seismic data without requiring as much attention as the target area. Areas above the impedance boundary, where reflections are less relevant for resolving the AOI, may be assigned a value of 0 to exclude them from the inversion process. Therefore, by applying the model mask, less relevant regions, such as those with “0” values, may be excluded from the inversion process, reducing calculations and enhancing computational efficiency.

By creating this model mask, the inversion algorithm may focus on the most relevant subsurface regions while avoiding unnecessary updates to well-defined or less significant areas. This approach optimizes the computational resources used in the inversion process and improves the accuracy and resolution of the velocity model, particularly in the target subsurface region beneath the impedance boundary.

At step 1010, method 1000 comprises performing, by the computing system 60, a second FWI to update the updated velocity model using the model mask and the input seismic data after muting and applying the data mask and smoothing the gradient to enhance a seismic image at the AOI.

In an embodiment, performing a second FWI to update the updated velocity model includes refining the velocity model further using the model mask, which ensures that only the relevant regions are updated. This process begins with the input seismic data that has already been preprocessed through muting and data masking. The muting process removes unwanted strong reflections from regions like the impedance boundary, while the data mask helps to adjust the amplitudes of the seismic signals to focus on the target area. These preprocessing steps may clean the data and allow the inversion process to concentrate on refining the subsurface features of interest.

The second FWI uses the seismic data in combination with the model mask to iteratively update the velocity model, specifically focusing on the AOI. The model mask may ensure that the inversion emphasizes refining areas directly related to the target, excluding regions that do not contribute significantly to improving the resolution of the subsurface features. This targeted-oriented inversion provides a way of avoiding complex seismic wave propagation in impedance boundaries such as subsalt regions, to obtain high resolution images on the AOIs located beneath the high impedance areas.

Additionally, smoothing the gradient during the second FWI helps to enhance the seismic image in the AOI by reducing noise and providing a more stable, accurate representation of the subsurface. The smoothing process may ensure that rapid, localized changes in the velocity model do not dominate the inversion results, leading to a more coherent and reliable velocity model. This improved model results in better seismic images that accurately represent the subsurface features of interest, ultimately improving the resolution and quality of the AOI in the updated velocity model.

In an embodiment, the impedance boundary may have complex geometrical structure and shape and the method 1000 may optionally include modifying the model mask iteratively to better account for the variations and intricacies of the impedance boundary. This iterative process may include adjusting the model mask based on additional seismic data insights and reapplying the modified model mask to the input seismic data, after muting and applying the data mask, as well as smoothing the gradient at each step. The method 1000 may be repeated multiple times using subsequent FWIs to update the updated velocity model and enhance the accuracy of the seismic image at the AOI.

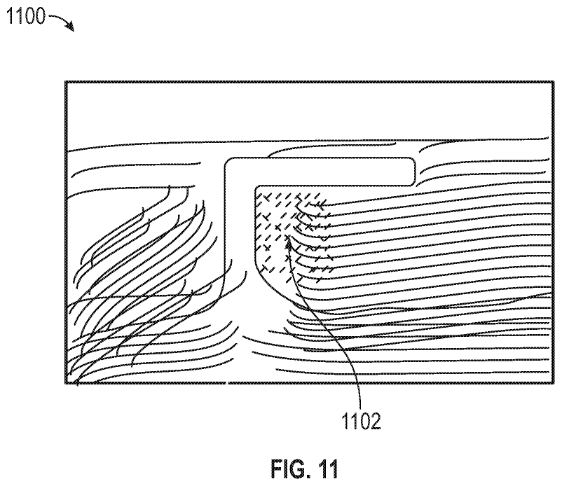

Referring now to FIG. 11, shown is a velocity model 1100 of a subsurface region. The velocity model 1100 may be obtained after performing the method 1000 of target oriented FWI process. As shown in FIG. 11, an AOI 1102 compared to the AOI 512 shown in FIG. 5 and the AOI 808 shown in FIG. 8 may have high resolution or model refinement. In an embodiment the FWI here is defined to include all variants of FWI. Certain examples of FWI can use pressure and/or multi-component data. Certain examples of FWI can use different approximations of physics (such as, for example, acoustic, elastic, visco-elastic, isotropic, and/or anisotropic). FWI can be used for different applications such as applications for estimating 3D velocities, applications for performing multi-parameter inversion, applications for deriving reflectivity volumes, applications for determining 4D difference volumes, applications for determining reflectivity gathers, and/or applications for determining probabilistic inversions, to name a few examples.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method performed by a computer-system, the method comprising:
identifying an area of interest (AOI) in a subsurface region of Earth based on a velocity model computed based on input seismic data;
muting at least a portion of the input seismic data based on reflection energy received from an impedance boundary in the subsurface region and applying a data mask to remaining input seismic data;
performing a first full-waveform inversion (FWI) to update the velocity model from a depth associated with the impedance boundary using the input seismic data after muting and applying the data mask to obtain an updated velocity model;
generating a model mask for the updated velocity model based on the AOI and the impedance boundary; and
performing a second FWI to update the updated velocity model using the model mask and the input seismic data after muting and applying the data mask and smoothing the gradient to enhance a seismic image at the AOI.

2. The method of claim 1, wherein before applying the data mask to the remaining input seismic data, the method further comprises selecting seismic sources based on at least one of a shape of the impedance boundary, a location of the impedance boundary, or the AOI.

3. The method of claim 2, wherein before selecting the seismic sources, the method further comprises obtaining the shape and the location based on the velocity model.

4. The method of claim 3, wherein before obtaining the shape and the location, the method further comprises performing an initial FWI to obtain the velocity model.

5. The method of claim 2, wherein the impedance boundary comprises a top and a base, and wherein muting at least the portion of the input seismic data and applying the data mask to the remaining input seismic data comprises:
muting reflections that correspond to the seismic sources and that are from a starting time to an end time corresponding to the base; and
adding gain to weak events corresponding to the seismic sources using an automatic gain controller (AGC), wherein the weak events comprise interactions of the seismic sources with the base and the AOI.

6. The method of claim 1, wherein the impedance boundary comprises a top and a base, and wherein generating the model mask comprises:
identifying a first area encompassing the base and the AOI based on the updated velocity model; and
adding a contrast to the first area to obtain the model mask.

7. The method of claim 6, further comprising identifying a second area that is based on the updated velocity model and that is different from the first area, wherein a first value of the first area is 1, wherein a second value of the second area is 0, and wherein a third value of a transition area that is between the first area and the second area changes gradually from 1 to 0.

8. A computing system comprising:
a memory configured to store instructions; and
one or more processors coupled to the memory and configured to execute the instructions to cause the computing system to:
identify an area of interest (AOI) in a subsurface region of Earth based on a velocity model computed based on input seismic data;
mute at least a portion of the input seismic data based on reflection energy received from an impedance boundary in the subsurface region and apply a data mask to remaining input seismic data;
perform a first full-waveform inversion (FWI) to update the velocity model from a depth associated with the impedance boundary using the input seismic data after muting and applying the data mask to obtain an updated velocity model;
generate a model mask for the updated velocity model based on the AOI and the impedance boundary; and
perform a second FWI to update the updated velocity model using the model mask and the input seismic data after muting and applying the data mask and smoothing the gradient to enhance a seismic image at the AOI.

9. The computing system of claim 8, wherein before applying the data mask to the remaining input seismic data, the one or more processors are further configured to execute the instructions to cause the computing system to select seismic sources based on at least one of a shape of the impedance boundary, a location of the impedance boundary, or the AOI.

10. The computing system of claim 9, wherein before selecting the seismic sources, the one or more processors are further configured to execute the instructions to cause the computing system to obtain the shape and the location based on the velocity model.

11. The computing system of claim 10, wherein before obtaining the shape and the location, the one or more processors are further configured to execute the instructions to cause the computing system to perform an initial FWI to obtain the velocity model.

12. The computing system of claim 9, wherein the impedance boundary comprises a top and a base, and wherein the one or more processors are further configured to execute the instructions to cause the computing system to:
mute reflections that correspond to the seismic sources and that are from a starting time to an end time corresponding to the base; and
add gain to weak events corresponding to the seismic sources using an automatic gain controller (AGC), wherein the weak events comprise interactions of the seismic sources with the base and the AOI.

13. The computing system of claim 8, wherein the impedance boundary comprises a top and a base, and wherein the one or more processors are further configured to execute the instructions to cause the computing system to:
identify a first area encompassing the base and the AOI based on the updated velocity model; and
add a contrast to the first area to obtain the model mask.

14. The computing system of claim 13, wherein the one or more processors are further configured to execute the instructions to cause the computing system to identify a second area that is based on the updated velocity model and that is different from the first area, wherein a first value of the first area is 1, wherein a second value of the second area is 0, and wherein a third value of a transition area that is between the first area and the second area changes gradually from 1 to 0.

15. A computer program product comprising computer-executable instructions that are stored on a non-transitory computer-readable medium and that, when executed by one or more processors, cause a computing system to:
identify an area of interest (AOI) in a subsurface region of Earth based on a velocity model computed based on input seismic data;
mute at least a portion of the input seismic data based on reflection energy received from an impedance boundary in the subsurface region and apply a data mask to remaining input seismic data;
perform a first full-waveform inversion (FWI) to update the velocity model from a depth associated with the impedance boundary using the input seismic data after muting and applying the data mask to obtain an updated velocity model;
generate a model mask for the updated velocity model based on the AOI and the impedance boundary; and
perform a second FWI to update the updated velocity model using the model mask and the input seismic data after muting and applying the data mask and smoothing the gradient to enhance a seismic image at the AOI.

16. The computer program product of claim 15, wherein before applying the data mask to the remaining input seismic data, the computer-executable instructions, when executed by the one or more processors, further cause the computing system to select seismic sources based on at least one of a shape of the impedance boundary, a location of the impedance boundary, or the AOI.

17. The computer program product of claim 16, wherein before selecting the seismic sources, the computer-executable instructions, when executed by the one or more processors, further cause the computing system to:
perform an initial FWI to obtain the velocity model; and
obtain the shape and the location based on the velocity model.

18. The computer program product of claim 16, wherein the impedance boundary comprises a top and a base, and wherein the computer-executable instructions, when executed by the one or more processors, further cause the computing system to:
mute reflections that correspond to the seismic sources and that are from a starting time to an end time corresponding to the base; and
add gain to weak events corresponding to the seismic sources using an automatic gain controller (AGC), wherein the weak events comprise interactions of the seismic sources with the base and the AOI.

19. The computer program product of claim 15, wherein the impedance boundary comprises a top and a base, and wherein the computer-executable instructions, when executed by the one or more processors, further cause the computing system to:
identify a first area encompassing the base and the AOI based on the updated velocity model; and
add a contrast to the first area to obtain the model mask.

20. The computer program product of claim 19, wherein the computer-executable instructions, when executed by the one or more processors, further cause the computing system to identify a second area that is based on the updated velocity model and that is different from the first area, wherein a first value of the first area is 1, wherein a second value of the second area is 0, and wherein a third value of a transition area that is between the first area and the second area changes gradually from 1 to 0.
